(19) United States
(12) Patent Application Publication
(10) Pub. No.: US 2017/0075339 A1
(43) Pub. Date: Mar. 16, 2017

(54) SYSTEM AND METHOD FOR CONTROLLING AND/OR ANALYZING AN INDUSTRIAL PROCESS BY MEANS OF AN OFF-SITE PROCESSING UNIT AND A REVISION MODULE FOR THE SYSTEM OPERATOR

(71) Applicant: SIEMENS AKTIENGESELLSCHAFT, München (DE)

(72) Inventor: Amit Verma, Erlangen (DE)

(73) Assignee: SIEMENS AKTIENGESELLSCHAFT, München (DE)

(21) Appl. No.: 15/265,358

(22) Filed: Sep. 14, 2016

(30) Foreign Application Priority Data
Sep. 15, 2015 (EP) 15185291.0

(51) Int. Cl. G05B 19/406; G05B 11/01

(52) U.S. Cl. CPC G05B 19/406; G05B 11/01; G05B 2219/14055

(57) ABSTRACT

A system for controlling and/or analyzing an industrial process having an on-site automation unit of a system operator, wherein the on-site automation unit performs a first process variable calculation and influences the industrial process. An off-site processing unit of a service operator different from the system operator is provided, wherein the off-site processing unit has an application and carries out a second process variable calculation and influences the industrial process directly or indirectly via the second process variable calculation. Local data is received by the off-site processing unit from the on-site automation unit via a data link. The off-site processing unit stores the local data in a primary storage. A revision module belonging to the off-site processing unit is provided wherein the revision module logs access to the primary storage by the application.

### CROSS-REFERENCES TO RELATED APPLICATIONS

This application claims the priority of European Patent Application, Serial No. 15185291.0, filed Sep. 15, 2015, pursuant to 35 U.S.C. 119(a)-(d), the disclosure of which is incorporated herein by reference in its entirety as if fully set forth herein.

### BACKGROUND OF THE INVENTION

The invention relates to a system and a method for controlling and/or analyzing an industrial process of a system operator by means of an off-site processing unit and a revision module for the system operator within the off-site processing unit.

The following discussion of related art is provided to assist the reader in understanding the advantages of the invention, and is not to be construed as an admission that this related art is prior art to this invention.

A large number of plants which carry out process control generally perform automation and control tasks. These tasks are generally carried out by automation units installed on-site and therefore in close proximity to the industrial process to be automated. Because of their limited processing power, such on-site automation units tend to be incapable of reproducing complex control structures or control and/or simulation strategies of the kind that are possible in higher-grade automation equipment. Such more complex control strategies which may require considerable computing capacity can include, for example, so-called model predictive controls (MPC) of the kind preferably used in technical processes. It is also often desirable to set up complex controls based on comprehensive historical data and to use them, for example, in so-called support vector machines (SVM) in order to be able to perform process optimizations on this basis. Therefore, such computation-intensive technical processes or data analysis models are often automated in the plant's higher-order control and monitoring system.

We are currently experiencing a trend toward central data analytics in external computer units (so-called cloud based analytics). These external computer units enable process controls for an industrial plant to be carried out in a cloud-based manner, wherein the industrial process data is collected by a plant for subsequent analysis in an external off-site processing unit. The result of the analysis is returned to the plant to improve process control and for process optimization. Because of its comprehensive analytical methods and the mainly self-learning techniques, cloud-based analytics allows process controls to be significantly improved. Moreover, historical data collected over a longer period is stored for analysis in an external computer unit. However, the external computer unit can also incorporate data of an MES (manufacturing execution system) or ERP (enterprise resource planning) system. Such MES or ERP systems possess a wide functional range, said functions likewise being based on the most diverse process data and process variable calculations. The intermediate data present in these systems which undergoes further processing may also have process control relevance. Whereas process variable calculations of the on-site automation units generally affect the industrial process directly (through setpoint inputs for a controller, for example), the process variable calculations of MES or ERP systems tend to affect the industrial process indirectly in that the MES is responsible for scheduling production processes e.g. by determining the production plan by collecting orders, or in that an MES performs checking and management of resources in order to prepare production or deal with production orders with the necessary material resources and/or to inform other systems about the progress of the production process. Or else it affects the industrial process indirectly through the exchange of process data, the status analysis of factory equipment items, material consumption information or historical or current production data.

The above mentioned data of an industrial process is sensitive data for the system operator, yet it tends to be stored in off-site processing units in the form of public or so-called hybrid clouds. This data therefore leaves the immediate sphere of responsibility and access range of the system operator, which is regarded as problematic. Add to this the fact that a public or hybrid cloud of this kind also stores and processes data of different system operators and companies. In addition, corporate organizations are subject to their own different security regulations in respect of their data handling, and these may be affected by higher-level security regulations that may differ from country to country on account of legislation. As soon as the data is outside corporate boundaries, it may be difficult for the company to ensure compliance with such rules and regulations.

Providers of cloud-based applications, or of clouds as such, know the problem of customers complaining about insufficient transparency as to which of their data and how much of it is stored and how it is used by the provider. As a result, customers find it difficult to accept and embrace cloud-based service offers.

Revision of a company's data can be easily carried out for data residing within corporate boundaries, but for data that is stored in a cloud—and of another provider to boot—this can be much more problematic.

There are currently no clear solutions for the problems described. Cloud-based service providers configure their data collectors such that they only collect relevant and contractually agreed data. However, customers require greater transparency as to what data is stored in the cloud and want to have more control over how the data is used and processed.

However, such control is also problematic for another reason. Cloud-based storage of data is heterogeneous. Public or hybrid cloud systems store different companies' data within a cloud using data collectors or data providers (agent-based or agentless). The company data may be stored in the cloud in different data stores. The data stores can be databases (SQL, Oracle, MS Access, etc.), file systems (files of different types), data archives, large data stores (Hadoop cluster, NoSQL, MongoDB, Rabbit, etc.), caches and so on. On the one hand, the data of different companies can be stored in models that are organizationally separate (so-called perfect multi-tenant models). According to this model, aggregation and encapsulation take place strictly by company. The stores are separate, each organization has its own SQL database and its own file system. On the other hand, data can be organized in models that are separate in terms of the data stores, i.e. the SQL database and/or the file system contain data of different companies (so-called mixed multi-tenant models).

In addition to the above described problems in respect of data transparency in the cloud, i.e. wanting to know what data is in the cloud at what point in time and in what degree of detail, system operators also face the problem of not knowing how this, their data, is being used in the cloud.

Data in a cloud is often replicated, however. Copies of data are written to temporary buffers, storage areas or files by applications that use this data. Copies of data are also retained in back-ups. Copies of data are also made where more in-depth analyses are to be performed using “big data” technology means. The problem is even more acute especially when the cloud also processes process data by means of different applications, such as condition monitoring or in-depth big data analyses.

Problems can also arise when an organization or system operator of an industrial plant changes service provider and therefore also cloud infrastructure. Once the data has been duplicated many times over and possibly on different storage media, it is virtually impossible to assure the owner of the data that his data has been completely deleted. Copies could remain in temporary stores, back-up archives or Hadoop clusters.

It would therefore be desirable and advantageous to provide an improved system and device which specify a system for controlling and/or analyzing an industrial process by means of an off-site processing unit, said system improving transparency and control for the provider of the data. In particular, the object is to create transparency as to how the data is used and managed.

### SUMMARY OF THE INVENTION

According to one aspect of the present invention, a system for controlling and/or analyzing an industrial process includes an on-site automation unit of a system operator, wherein the on-site automation unit performs a first process variable calculation and influences the industrial process; an off-site processing unit of a service operator different from the system operator, wherein the off-site processing unit has an application and carries out an second process variable calculation and influences the industrial process directly or indirectly via the second process variable calculation; local data received by the off-site processing unit from the on-site automation unit; a data link via which the off-site processing unit receives said local data from the on-site automation unit; a primary storage in which the off-site processing unit stores the local data; and a revision module belonging to the off-site processing unit wherein the revision module logs access to the primary storage by the application.

Accordingly, the system for controlling an industrial process has an on-site automation unit of a system operator. The industrial plant can be any plant having a production or manufacturing process in an industrial environment. On-site means that the automation or computer unit, hereinafter referred to, in general, as automation unit, is an integral part of the original automation system and is generally disposed close to the process. The on-site automation unit performs a first process variable calculation. For this purpose, the on-site automation unit is linked into the industrial process by means of sensors and actuators. Process input variables are the sensors and actuators which are generally read cyclically by the input device for controlling the processes and temporarily stored and are therefore available for further software-based processing by the processors of the automation components. The specific software-based processing within the on-site automation unit takes place according to a process control algorithm. The output variables of this processing, i.e. the results of the process control algorithm of the on-site automation unit, likewise generally become cyclically process-active via an output device of the on-site automation unit. However, the on-site automation unit can also be an MES (manufacturing execution system) or ERP (enterprise resource planning) system. The intermediate data present in these systems which is subject to further processing shall come under the term first process variable calculations used here. While the first process variable calculation of the on-site automation unit generally affects the industrial process directly (e.g. through setpoint inputs for a controller), the process variable calculations of MES or ERP systems tend to affect the industrial process indirectly in that the MES is responsible for scheduling production processes e.g. by determining the production plan by collecting orders, or in that an MES performs checking and management of resources in order to prepare production or deal with production orders with the necessary material resources and/or to inform other systems about the progress of the production process. Or else it affects the industrial process indirectly through the exchange of process data, the status analysis of factory equipment items, material consumption information or historical or current production data.

The system additionally has at least one off-site processing unit (cloud processing unit) which performs a second process variable calculation using the applications running thereon and for this purpose receives local data from the on-site automation unit via a data link. This local data is system operator data. The data link is implemented via known communication mechanisms and standardized interfaces. The communication mechanisms include, for example, the OPC (OPC DA, OPC UA) or TCP/IP (Profinet) communication standards which allow independent processing units to be combined to form a distributed system. The standard interfaces include RPC, OLEDDB or SQL. A processing unit shall be deemed to be off-site when it is located physically and/or functionally outside the original automation system and is within the sphere of responsibility of a service provider and has therefore left the system operator's sphere of responsibility.

The off-site processing unit has at least one application and performs a second process variable calculation in parallel with or in addition to the calculation of the first process variable calculation of the on-site automation unit. The more complex second process variable calculation will generally also be based on a larger amount of data. When this data can be provided by the industrial process itself (e.g. by additional and hitherto unused sensors or actuators), it is likewise read in and provided via the on-site automation unit. However, such local data can also comprise historical data or intermediate data of the kind present, for example, within the on-site automation unit itself. The calculations that are carried out in the off-site processing unit are generally much more complex and computation-intensive than those which can be carried out in the on-site automation unit. Thus the off-site processing unit performs advanced control functions such as are known from MPC controllers, for example. Because of the larger amount of data, particularly historical data, the process control algorithms also include, for example, model predictive control (MPC) algorithms based on so-called support vector machines (SVM). Via the second process variable calculation, the off-site processing unit can directly influence the process, the second process variable calculation can become directly effective in the process. In addition, the applications running on the off-site processing unit can reproduce condition monitoring systems, simulation systems or history systems and, within that off-site processing unit, perform additional evaluations and analytics and also access local data in the on-site automation unit for this purpose. In this respect, said second process variable calculation shall also include calculations based on local data which do not have a controlling effect on the process, but shall be made available by applications to the system operator for other purposes, e.g. for evaluation purposes, and in this respect have an indirect effect on the industrial process in that they can make it safer or more efficient. On being input to the off-site processing unit, the local data is stored in primary storage which the application accesses to execute its program. Such primary storage can be designed as a perfect or mixed multi-tenant model.

The off-site processing unit now has a revision module, wherein the revision module logs the further accessing of the primary storage by an application. In this context, logging is to be understood as meaning the direct recording of events (reads, writes) and the further processing and use for each item of data stored in primary storage. The accesses are initiated by the applications, i.e. the individual programs running within the off-site processing unit.

According to another advantageous feature of the present invention, the revision module can log not only access to the data in primary storage but also access to secondary storage. Secondary storage is to be understood as meaning temporary storage. This can be, for example, Hadoop stores, temporary files and buffers as well as back-up systems. Different applications can access secondary storage alternately or even cumulatively.

According to another advantageous feature of the present invention, the revision module can include at least one log file which logs the accesses using at least the parameters user (user group), data category, duplicate. This provides a record of what data has been used where and how, and to what storage area it has possibly been copied. The entry for the “user” or the “user group” is useful when the data is used in the off-site processing unit not only by the service operator of the off-site processing unit, but when a number of other users are to access the data with in some cases their own application. Thus it is conceivable that partners of the service operator shall also access the system operator's data for particular services and/or analyses. The partner shall also possibly have access to different service operators' data depending on his analyses. Other cases are conceivable in which, for example, users are to have access to this data for very specific applications. For example, a user could have been defined with the role “Human Resource” and have obtained access to particular personnel data.

“Data category” is used to log which group of data has undergone further processing or duplication. This provides an advantageous way of checking whether a user, in his role, has actually accessed and further processed only permitted data. The “copy” entry records whether and, if so, where a duplication has been found in which storage area. When a duplicated item of data is deleted again from a storage area, preferably from a secondary storage area, the log file is updated accordingly. Via the log file, the system operator or the organization owning the data obtains an overview as to which of its data has been processed and possibly duplicated when and by whom.

According to another advantageous feature of the present invention, the system operator or owner of the data can obtain access from outside the on-site automation unit. Access outside of the on-site automation unit means independent access by the system operator, primarily time- and location-independent access by the system operator, i.e. even when the off-site processing unit performs control or analytical functions. The data owner can now obtain at any time a complete overview as to what data or categories of data have been copied where in the off-site processing unit by which user. This is advantageous for both the system operator and the service operator. Thus the system operator can use the revision module for compliance purposes, and the service operator can demonstrate to the system operator that only the possibly contractually agreed movement of data takes place.

According to another aspect of the present invention, an off-site processing unit for controlling and/or analyzing at least one industrial process of a system operator includes one or more applications and performs a process variable calculation for the at least one industrial process on the basis of local data. Via a data link, the off-site processing unit receives said local data from an on-site automation unit, whose data is stored in primary storage of the off-site processing unit. The on-site automation unit has a revision module which logs access to primary storage by the one or more applications. This logging ensures that all the read and write accesses, i.e. all the activities of the application relating to primary storage, are simultaneously recorded. Further processing and use can therefore be recorded for each item of data stored in primary storage.

In addition to the above mentioned primary storage, the infrastructure of the off-site processing unit usually also has other secondary storage areas which are used by applications for executing their program. According to another advantageous feature of the present invention, these stores termed secondary storage are also encompassed by the revision module and the accesses to these secondary storages are also logged. This ensures complete logging of all the activities of the applications in relation to the storage areas and therefore produces a comprehensive log in respect of the activities for subsequent evaluations.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows a system for distributed process control of an industrial plant having an off-site processing unit;

FIG. 2 shows a mode of operation of a revision module within an off-site processing unit; and

FIG. 3 shows a possible extract from a log file for the system operator.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments may be illustrated by graphic symbols, phantom lines, diagrammatic representations and fragmentary views. In certain instances, details which are not necessary for an understanding of the present invention or which render other details difficult to perceive may have been omitted.

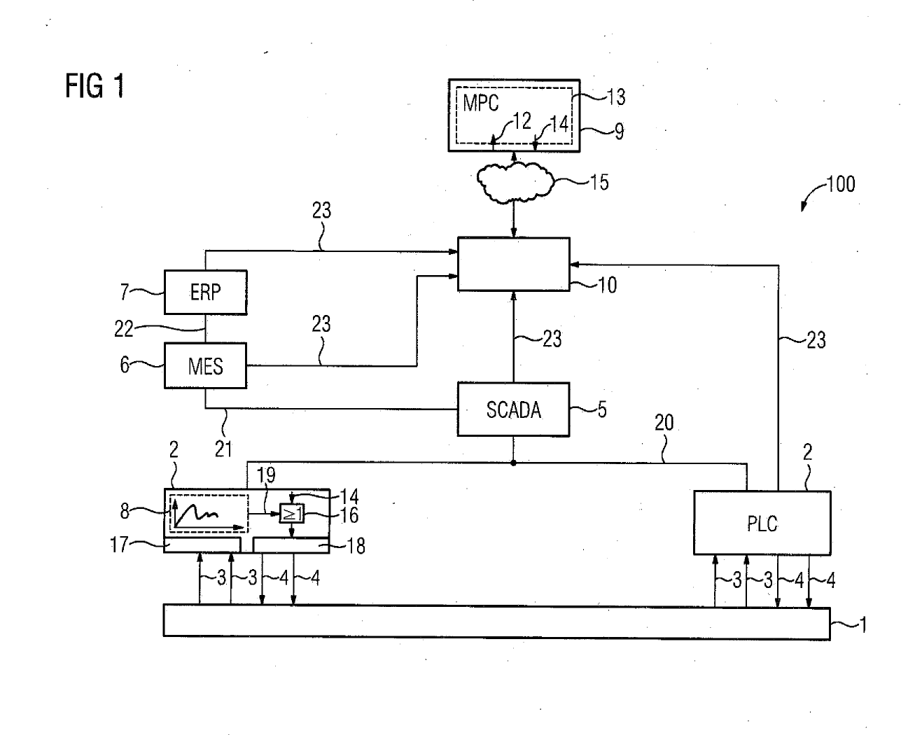

Turning now to the drawing, and in particular to FIG. 1, there is shown a system, generally designated by reference numeral 100, for controlling an industrial process 1 which can be any production process in the manufacturing sector. The industrial process can be a process which takes place within one location, or else across a plurality of locations. The industrial process 1 is open- and closed-loop controlled via decentralized on-site automation units 2. These are equipped with one or more processors (not shown) which execute software encoded instructions in conjunction with the necessary buffer stores. The instructions relate to all the process control algorithms for open- and closed-loop control of the industrial process and to data communication between the units. For open- and closed-loop control of the process, the on-site automation unit 2 has a number of operative connections 3 to sensors and actuators not shown in greater detail in FIG. 1. Via this connection, the input device 17 reads in the local data which is thereafter available in a primary storage area of the on-site automation unit. Control commands from the output device 18 to the process's actuators (not shown in greater detail in FIG. 1) are implemented via the operative connections 4. Two on-site automation units 2 are shown by way of example, although in practice a plurality of on-site automation units are used for open-loop and closed-loop control and monitoring of the process. The on-site automation units 2 are connected via a data link 20 to the monitoring system 5 responsible for controlling and monitoring of the industrial process 1. The monitoring system 5 (SCADA) provides a data link 21 to the manufacturing execution system 6 which in turn provides a data link 22 to an enterprise resource planning system 7. The manufacturing execution system 6 and the enterprise resource planning system 7 can also communicate with the monitoring system 5 via the data link 20. The on-site automation units 2 execute process control algorithms 8 on the basis of the local data generated via operative connection 3. These are process-effective monitoring analyses and control functions which generally include simpler and less complex analysis and control tasks. The result of this process control algorithm is held available as a first process variable calculation 19 in the on-site automation unit 2 for further use and, unless required, is overwritten in a subsequent cycle. However, the first process variable calculation 19 is likewise influenced by calculations within the higher-level systems 5, 6, 7. Thus, for example, planning requirements based on customer orders or material deliveries from the MES and ERP system mean that particular production processes are to be carried out in a slower, more energy-optimized or quicker manner. The SCADA can, for example, likewise influence an upstream production process (e.g. filling) because of malfunctions elsewhere in the production process (e.g. in the packaging department).

In this configuration, the system 100 is operational and able to fulfill its open-loop control, closed-loop control and monitoring tasks.

The system 100 is extended to include an off-site processing unit 9. The latter is equipped with one or more processors not shown here which execute the software-encoded instructions in conjunction with the temporary stores. The instructions relate to all the process control algorithms for open-loop control, closed-loop control and analytics of the process and to data communication between the units. The off-site processing unit 9 is connected to the on-site automation units via a data link 15 and the gateway 10. The data link 15 is preferably implemented via the Internet in either a cabled or wireless manner. The gateway 10 can be a data collector unit which receives from the automation and units 2, 5, 6, 7, via the data link 23, all the local data required in the off-site processing unit 9 for the above mentioned process control algorithms for the open-loop control, closed-loop control and analytics of the industrial process 1 that are executed there. The data link 23 shown is to be understood in terms of function; physically, it can be a separate network, or the data collector unit 10 is connected to an existing network within the system 100, e.g. 20, 21. The off-site processing unit 9 executes process control algorithms 13 on the basis of input process variables 12 which are provided by the gateway 10 and which are based essentially on the data generated via the operative connection 3, and outputs results 14 of these calculations. The input process variables 12 can also be based on the historical data available in the on-site automation unit 2. Alternatively or additionally, the input process variables 12 can be based on historical data available in the off-site processing unit 9 itself. By way of example, FIG. 1 shows an MPC control structure as a process control algorithm 13. However, more comprehensive data analytics can also be the object of the above mentioned algorithm and the results 14 are results of such analytical functions. The results 14 are transmitted to the on-site automation units 2, 5, 6, 7. The communications path via the gateway 10 can be used for this purpose, or alternatively a separate communications path (not shown here) is used. When the results 14 are to affect the industrial process 1 directly, the checking device 16 decides within the on-site automation unit 2 whether the results 14 become process-effective via the output device 18. Alternatively, however, results 14 can also be those of data analytics of a condition monitoring system, for example, and only be transmitted to the on-site automation units 6,7. In this case, such results of analytical functions can also be made available to the ERP or MES, e.g. when it is a matter of the analytical function determining the failure of a component in the context of condition monitoring. It is also conceivable that results are only stored and retained within the off-site processing unit 9 and made available for further evaluations.

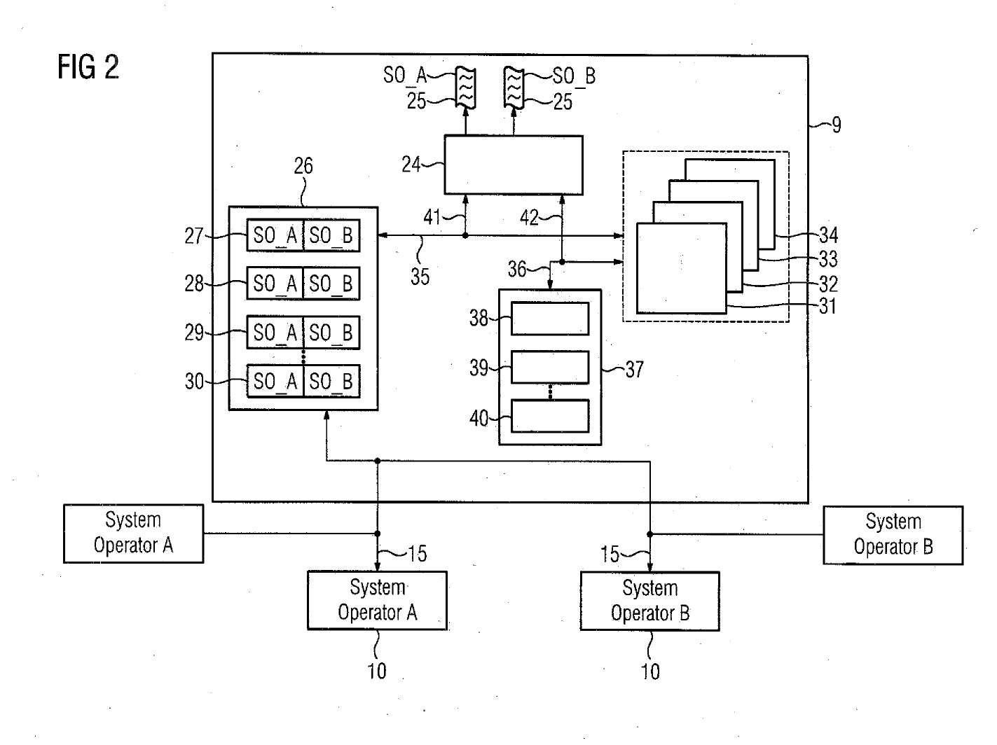

FIG. 2 schematically illustrates the mode of operation of the revision module 24 within the off-site processing unit 9. The local data of the on-site automation units 2, 5, 6, 7 is transferred over the data link 15 via the gateway 10 of the respective system operator SO_A, SO_B (system operator A, system operator B) by means of agents. The data of the system operators is stored in the primary storage 26 in the off-site processing unit 9. The primary storage is not to be understood physically as a single storage. Rather it can comprise a number of different storage media such as, for example, databases 27, file systems 28, in-memory databases 29, archives 30, etc. The primary storage 26 can—when, as in this exemplary embodiment, the off-site processing unit is connected to data sources of a plurality of system operators. By way of example, FIG. 2 shows the storage of the data in a database and in a file system in a mixed multi-tenant model. Alternatively, the data can also be stored in a perfect multi-tenant model, i.e. having a separate database and/or file system for the data of the respective system operator. The applications 31, 32, 33, 34 read-access and possibly also write-access the primary storage data. The read and write accesses of the applications to the primary storage data are indicated by the arrow 35. The cloud-based applications 31 to 34 access the primary storage data in order to further process it, analyze it or display it via user interfaces. The applications 31, 32, 33, 34 can be applications of the service operator or of another service partner or even of the system operator itself. For example, the application 31 can be a condition monitoring application 31 which reads data relating to the status of machines from primary storage, then processes it in a temporary store for a fast Fourier transform and subjects the intermediate results to further analysis for preventive maintenance suggestions. A sales forecast application 32 reads historical data from the primary storage and copies it to a Hadoop store for further big data analytics. A backup application 33 makes rolling storage dumps from the primary storage to the secondary storage. An ERP application 34 accesses the primary storage data in order, for example, to calculate particular KPI (key performance indicators) for production. The common feature of all the applications is that they use the secondary storage 37 to store copies of the primary storage data or intermediate results there. The secondary storage 37 is likewise not to be understood physically as a single storage. It can also comprise a number of different storage media or mechanisms such as, for example, a Hadoop store 38, temporary storage areas 39 or backup file systems 40, etc. The applications 31-34 have read and/or write access, indicated by the arrow 36.

The revision module 24 logs—illustrated by the arrow 41—all the accesses of an application to the primary storage 26. The revision module 24 also logs, as indicated by the arrow 42, all the accesses of an application to the secondary storage 37. The module 24 generates a log file 25 in which details regarding the access and the way in which the data is used are recorded. Different log files 25 are provided for the different system operators (SO). By way of example, FIG. 2 shows the log files 25 for the system operator A (SO_A) and B (SO_B).

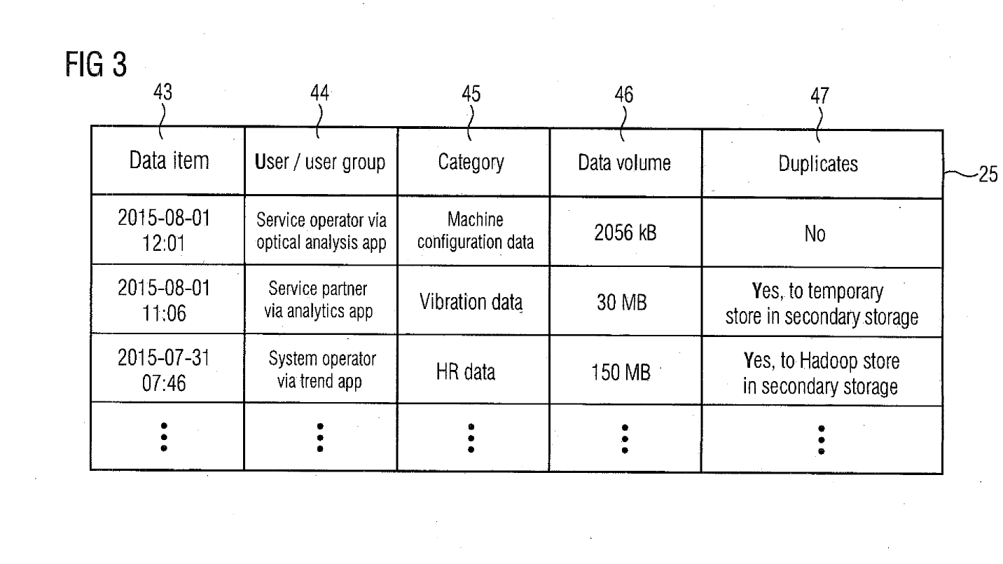

FIG. 3 shows an example of a possible extract from a log file 25 for the system operator A. The time at which an item of data 43 is accessed is noted. Noted in another entry is the user/user group 44 by which the access was made. This can be e.g. the service operator, a partner of the service operator or the system operator itself. There is also an entry recording the application by which the user has accessed the data. The data is assigned data categories 45 under which it is recorded in the log file. By way of example, the categories here are “machine configuration data”, “vibration data”, “human resource data”. For each entry in the log file, the data volume 46 of the processed data is additionally recorded. Information as to whether duplicates have been made and, when so, the store/storage area in which they are located, is provided by the entry 47.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A system for controlling and/or analyzing an industrial process, comprising:
an on-site automation unit of a system operator, said on-site automation unit configured to execute a first process variable calculation and to influence the industrial process;
an off-site processing unit of a service operator different from the system operator, said off-site processing unit including an application and configured to carry out a second process variable calculation and to influence the industrial process directly or indirectly via the second process variable calculation;
a data link via which the off-site processing unit receives local data from the on-site automation unit; and
a primary storage configured to store the local data;
said off-site processing unit including a revision module configured to log access to the primary storage by the application.

2. The system of claim 1, wherein the off-site processing unit includes a secondary storage configured to execute the application, said revision module being configured to log access to the secondary storage.

3. The system of claim 1, wherein the revision module includes a log file configured to log the access to the primary storage using parameters “user”, “data category”, and “duplicate”.

4. The system of claim 2, wherein the revision module includes a log file configured to log the access to the secondary storage using parameters “user”, “data category”, and “duplicate”.

5. The system of claim 3, wherein the off-site processing unit is configured to provide access to the revision module and/or the log file from outside the on-site automation unit.

6. The system of claim 4, wherein the off-site processing unit is configured to provide access to the revision module and/or the log file from outside the on-site automation unit.

7. An off-site processing unit of a service operator for controlling and/or analyzing an industrial process of a system operator, said off-site processing unit configured to execute a process variable calculation for the industrial process and to receive local data from an on-site automation unit via a data link, said off-site processing unit comprising:
an application;
a primary storage configured to store the local data; and
a revision module configured to log access by the application to the primary storage.

8. The off-site processing unit of claim 7, wherein the off-site processing unit includes a secondary storage for executing the application, said revision module configured to log access to the secondary storage.

9. The off-site processing unit of claim 7, wherein the revision module includes a log file configured to log the accesses to the primary storage using parameters “user”, “data category”, and “duplicate”.

10. The off-site processing unit of claim 8, wherein the revision module includes a log file configured to log the accesses to the secondary storage using parameters “user”, “data category”, and “duplicate”.

11. The off-site processing unit of claim 7, wherein the revision module is configured to log the local data of the on-site automation unit.

12. The off-site processing unit of claim 9, wherein the revision module includes a log file for each system operator.

13. The off-site processing unit of claim 10, wherein the revision module includes a log file for each system operator.
